(19) United States
(12) Patent Application Publication
(10) Pub. No.: US 2017/0351483 A1
(43) Pub. Date: Dec. 7, 2017

(54) METHOD FOR ENHANCED CONCERT AUDIO EXPERIENCE

(71) Applicant: Panasonic Automotive Systems Company of America, Division of Panasonic Corporation of North America, Peachtree City, GA (US)

(72) Inventor: JOHN LUKE HOLDREN, FERNDALE, MI (US)

(73) Assignee: Panasonic Automotive Systems Company of America, Division of Panasonic Corporation of North America

(21) Appl. No.: 15/606,277

(22) Filed: May 26, 2017

Related U.S. Application Data
(60) Provisional application No. 62/345,071, filed on Jun. 3, 2016.

(51) Int. Cl. G06F 3/16; H04B 5/00; H04H 60/04; H04R 3/12; G11B 27/038; H04R 29/00

(52) U.S. Cl. CPC G06F 3/165; H04R 3/12; G11B 27/038; H04B 5/0031; H04H 60/04; G06F 3/162; H04R 29/008; H04R 2420/01; H04R 2430/01; H04S 2400/15

(57) ABSTRACT

An enhanced concert audio experience arrangement includes a mixing console that receives a plurality of audio signals. Each audio signal is received from a respective microphone of a plurality of microphones. The mixing console mixes the audio signals into a plurality of combinations of audio signals. Each combination includes one or more selected ones of the audio signals. A transceiver is communicatively coupled to the mixing console and transmits air-borne signals including the combinations of audio signals. A mobile personal electronic device is communicatively coupled to the transceiver and enables a human user to select one of the combinations of audio signals transmitted by the transceiver, and listen to the selected combination of audio signals.

### CROSS-REFERENCED TO RELATED APPLICATIONS

This application claims benefit of U.S. Provisional Application No. 62/345,071 filed on Jun. 3, 2016, which the disclosure of which is hereby incorporated by reference in its entirety for all purposes.

### FIELD OF THE INVENTION

The disclosure relates to the field of audio systems, and, more particularly, to audio systems which may be used to produce audio signals at a live performance.

### BACKGROUND OF THE INVENTION

Currently, one of the most common complaints from people attending a concert or other live performance is poor quality of sound.

### SUMMARY

The present invention may improve a concert attendee's overall aural experience through the use of Wi-Fi Direct (Wi-Di) protocol working in synchronization with existing sound reinforcement components, Wi-Di enabled consumer electronic devices, and a mobile application. The invention solves the demand for high-quality audio distribution in environments with poor acoustic properties. In particular, the invention may provide alternative listening experiences to those provided by a venue's public address (PA) system.

The invention may utilize a Wi-Fi direct protocol in conjunction with a subscription-based mobile application, which enables users to select and customize an audio mix during a concert performance. With the broad deployment and acceptance of mobile devices and pay-for-service mobile applications, it is now possible to provide and monetize a custom live auditory experience by use of the present invention.

In one embodiment, the invention comprises an enhanced concert audio experience arrangement including a mixing console that receives a plurality of audio signals. Each audio signal is received from a respective microphone of a plurality of microphones. The mixing console mixes the audio signals into a plurality of combinations of audio signals. Each combination includes one or more selected ones of the audio signals. A transceiver is communicatively coupled to the mixing console and transmits air-borne signals including the combinations of audio signals. A mobile personal electronic device is communicatively coupled to the transceiver and enables a human user to select one of the combinations of audio signals transmitted by the transceiver, and listen to the selected combination of audio signals.

In another embodiment, the invention comprises a method of providing an enhanced concert audio experience, including receiving a plurality of audio signals. Each audio signal is received from a respective microphone of a plurality of microphones. The audio signals are mixed into a plurality of combinations of audio signals. Each combination includes one or more selected ones of the audio signals. Air-borne signals including the combinations of audio signals are transmitted. A human user is enabled to select one of the combinations of audio signals and listen to the selected combination of audio signals.

In yet another embodiment, the invention comprises an enhanced concert audio experience arrangement including a mixing device receiving a plurality of audio signals. Each audio signal is received from a respective microphone of a plurality of microphones. The audio signals are mixed into a plurality of combinations of audio signals. Each combination includes one or more selected ones of the audio signals. A transceiver is communicatively coupled to the mixing device and transmits air-borne signals including the combinations of audio signals. A mobile personal electronic device is communicatively coupled to the transceiver and confirms that a human user has a subscription to the audio signals transmitted by the transceiver. The mobile personal electronic device enables the human user to select and listen to one of the combinations of audio signals transmitted by the transceiver only if the mobile personal electronic device has confirmed that the human user has a subscription to the audio signals transmitted by the transceiver.

An advantage of the present invention is that it offers users an audio quality far surpassing what he might otherwise be able to experience due to his non-ideal listening position coupled with limitations of the audio system and of the listening environment.

### BRIEF DESCRIPTION OF THE DRAWINGS

A better understanding of the present invention will be had upon reference to the following description in conjunction with the accompanying drawings.

FIG. 1 is a block diagram of one embodiment of an enhanced concert audio experience arrangement of the present invention.

FIG. 2 is a flow chart of one method of the present invention for providing an enhanced concert audio experience.

### DETAILED DESCRIPTION OF THE PREFERRED EMBODIMENTS

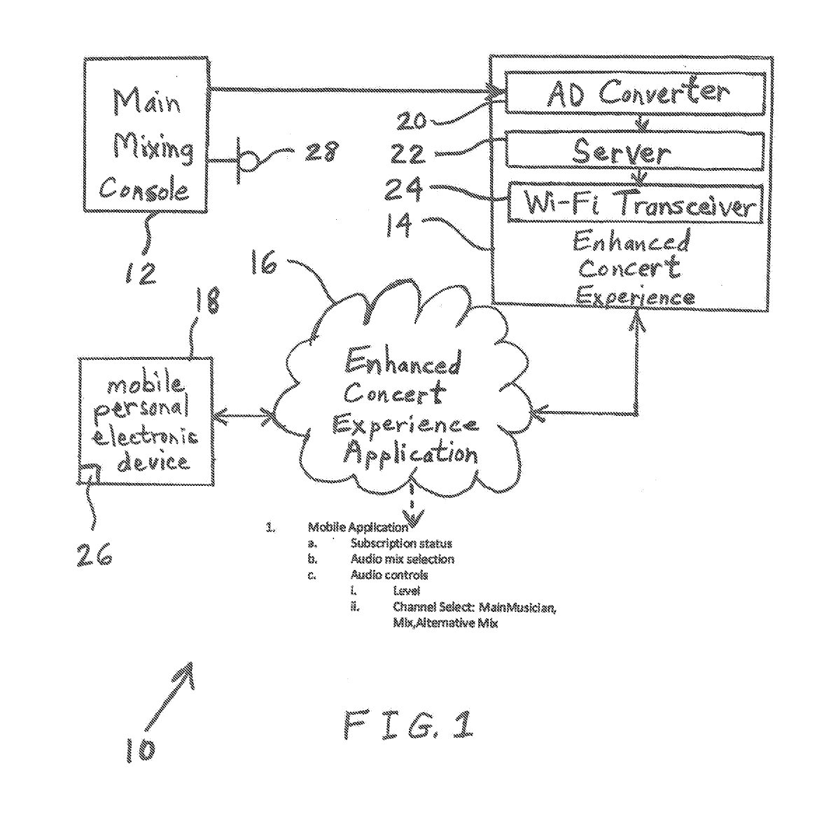

FIG. 1 illustrates one embodiment of an enhanced concert audio experience arrangement 10 of the present invention, including a main mixing console 12, which may be a venue sound mixing board, an enhanced concert experience module 14, an enhanced concert experience application 16, and a mobile personal electronic device 18. Enhanced concert experience module 14 includes an analog-to-digital converter 20, a server 22, and a Wi-Fi direct transceiver 24.

Mobile personal electronic device 18 may be in the form of a smartphone, for example, and may include a digital-to-analog converter 26. Enhanced concert experience application 16 is a mobile application providing a subscription status, an audio mix selection, and audio controls for controlling a volume level and a channel selection. The channel selection may enable the user to choose between a main channel, a musician mix channel, and an alternative mix channel.

During use, audible music may be picked up by a plurality of microphones 28 located near the musicians. Each microphone 28 may be positioned to pick up the music from a different corresponding musician, or from a different combination of musicians. Main mixing console 12 may receive the signals from microphones 28 and may be used to mix the signals to broadcast over the loudspeakers in the venue. Main mixing console 12 may also transmit the mixed signals to enhanced concert experience module 14. Further, main mixing console 12 may also provide alternative mixes and combinations of the various audio signals from microphones 28, and may transmit these alternative mixed signals to enhanced concert experience module 14. However, main mixing console 12 may also transmit the individual analog microphone signals in an unmixed state to enhanced concert experience module 14.

Analog-to-digital converter 20 of module 14 may convert the analog audio signals into digital audio signals, which server 22 transmits to transceiver 24. Transceiver 24 then locally broadcasts digital air-borne audio signals each representing a respective one of the various mixed signals produced by console 12 or one of the individual audio signals produced by microphones 28.

Mobile personal electronic device 18 may receive the digital air-borne audio signals broadcast by transceiver 24. Application 16, as operating on device 18, may process the digital air-borne audio signals and make them available to the user of mobile device 18. Application 16 may first verify that the user and mobile device 18 have a valid paid-up subscription that permits application 16 to provide the user with the various mix options. Application 16 may provide a user interface that enables the user to select an audio mix including a selected mix of one or more of the audio signals broadcast by transceiver 24. Application 16 may also provide audio controls on the user interface of device 18 that enable the user to select a volume level and one of the audio channels, wherein each channel carries a respective mix of the audio signals. The mixes of audio signals that may be selected may include a main mix that is being broadcast on the venue's loudspeakers; a musician mix that isolates and/or emphasizes a particular one of the musicians, or a particular subset of the musicians; an alternative mix produced by console 12 that may have subtler differences from the main mix; and custom mixes that the user may create for himself by selecting one or more of the individual microphone signals of the respective microphone amplifier. The user may further customize his mix by adjusting the volume of each of the individual microphone signals relative to each other.

Regardless of which mix is selected by the user, the mix may be converted to an analog signal by digital-to-analog converter 26. Device 18 may have a headphone output jack (not shown) that enables the user to listen to his selected mix through a headphone plugged into the headphone output jack. The user may also listen to his selected mix via a loudspeaker built into device 18.

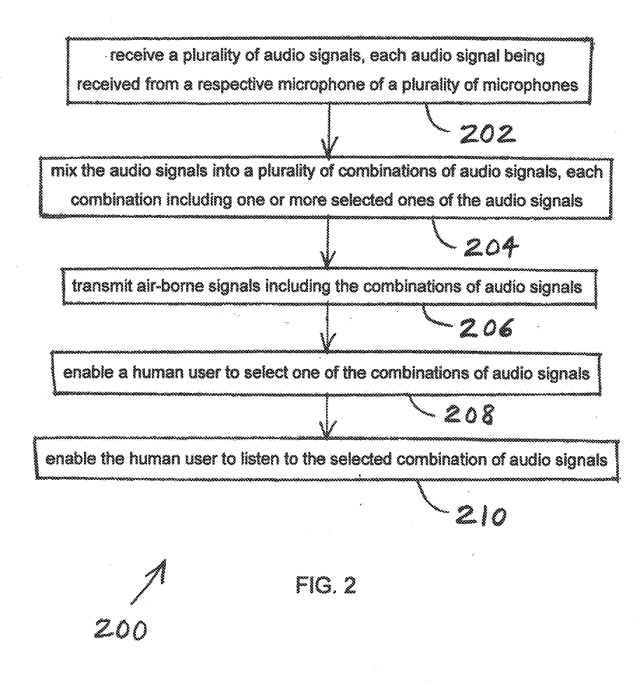

FIG. 2 illustrates one method 200 of the present invention for providing an enhanced concert audio experience. In a first step 202, a plurality of audio signals are received. Each audio signal is received from a respective microphone of a plurality of microphones. For example, console 12 may receive a respective audio signal from each of a plurality of microphones 28.

In a next step 204, the audio signals are mixed into a plurality of combinations of audio signals. Each combination includes one or more selected ones of the audio signals. For example, mixing console 12 may mix the audio signals from microphones 28 in various combinations of one, two, or three or more of the audio signals.

Next, in step 206, air-borne signals including the combinations of audio signals are transmitted. For example, transceiver 24 may locally broadcast digital air-borne audio signals each representing a respective one of the various mixed signals produced by console 12 or one of the individual audio signals produced by microphones 28.

In step 208, a human user is enabled to select one of the combinations of audio signals. For example, application 16 may provide a user interface that enables the user to select an audio mix including a selected mix of one or more of the audio signals broadcast by transceiver 24.

In a final step 210, the human user is enabled to listen to the selected combination of audio signals. For example, mobile personal electronic device 18 may receive the digital air-borne audio signals broadcast by transceiver 24. Application 16, as operating on device 18, may process the digital air-borne audio signals and make them available to the user of mobile device 18. The user may be enabled to listen to the selected combination of audio signals via headphones connected to a jack on mobile personal electronic device 18.

The invention has been described as being applied to a live performance in the form of a concert. However, the invention may also be applied to a speech that is audibly translated into other languages on other respective channels. The application may enable the user to select a channel corresponding to the language in which he would like to listen to the speech. Further, the application may extend to any other forum, public or private, where the desired performance is required; for example, a drive-in movie theater.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. An enhanced concert audio experience arrangement, comprising:
a mixing console configured to:
receive a plurality of audio signals, each said audio signal being received from a respective microphone of a plurality of microphones; and
mix the audio signals into a plurality of combinations of audio signals, each said combination including one or more selected ones of the audio signals;
a transceiver communicatively coupled to the mixing console and configured to transmit air-borne signals including the combinations of audio signals; and
a mobile personal electronic device communicatively coupled to the transceiver and configured to enable a human user to:
select one of the combinations of audio signals transmitted by the transceiver; and
listen to the selected combination of audio signals.

2. The arrangement of claim 1 wherein the mobile personal electronic device is configured to:
confirm that the human user has a subscription to the audio signals transmitted by the transceiver; and
perform the enabling of the user to select and listen to one of the combinations of audio signals only if the mobile personal electronic device has confirmed that the human user has a subscription to the audio signals transmitted by the transceiver.

3. The arrangement of claim 1 wherein the combinations of audio signals include an audio signal focused on a particular musician.

4. The arrangement of claim 1 wherein the combinations of audio signals comprise combinations of analog audio signals, the arrangement further comprising an analog-to-digital converter configured to convert the combinations of analog audio signals into combinations of digital audio signals, the transceiver being configured to transmit air-borne signals including the combinations of digital audio signals.

5. The arrangement of claim 4 wherein the mobile personal electronic device includes a digital-to-analog converter configured to convert the combinations of digital audio signals into combinations of analog audio signals.

6. The arrangement of claim 4 further comprising a server interconnecting the analog-to-digital converter and the transceiver.

7. The arrangement of claim 1 wherein the transceiver comprises a Wi-Fi direct transceiver.

8. A method of providing an enhanced concert audio experience, the method comprising:
receiving a plurality of audio signals, each said audio signal being received from a respective microphone of a plurality of microphones;
mixing the audio signals into a plurality of combinations of audio signals, each said combination including one or more selected ones of the audio signals;
transmitting air-borne signals including the combinations of audio signals;
enabling a human user to select one of the combinations of audio signals; and
enabling the human user to listen to the selected combination of audio signals.

9. The method of claim 8 comprising the further step of confirming that the human user has a subscription to the transmitted air-borne audio signals, and wherein the user is enabling to select and listen to one of the combinations of audio signals only if it has been confirmed that the human user has a subscription to the transmitted air-borne audio signals.

10. The method of claim 8 wherein the combinations of audio signals include an audio signal focused on a particular musician.

11. The method of claim 8 wherein the combinations of audio signals comprise combinations of analog audio signals, the method further comprising converting the combinations of analog audio signals into combinations of digital audio signals, the transmitted air-borne signals including the combinations of digital audio signals.

12. The method of claim 11 comprising the further step of converting the combinations of digital audio signals into combinations of analog audio signals.

13. The method of claim 11 further comprising enabling the user to set a volume level at which he listens to the selected combination of audio signals.

14. The method of claim 8 wherein the human user is enabled to listen to the selected combination of audio signals via headphones connected to a jack on a mobile telephone.

15. An enhanced concert audio experience arrangement, comprising:
a mixing device configured to:
receive a plurality of audio signals, each said audio signal being received from a respective microphone of a plurality of microphones; and
mix the audio signals into a plurality of combinations of audio signals, each said combination including one or more selected ones of the audio signals;
a transceiver communicatively coupled to the mixing device and configured to transmit air-borne signals including the combinations of audio signals; and
a mobile personal electronic device communicatively coupled to the transceiver and configured to:
confirm that a human user has a subscription to the audio signals transmitted by the transceiver, and
enable the human user to select and listen to one of the combinations of audio signals transmitted by the transceiver only if the mobile personal electronic device has confirmed that the human user has a subscription to the audio signals transmitted by the transceiver.

16. The arrangement of claim 15 wherein the combinations of audio signals include an audio signal focused on a particular musician.

17. The arrangement of claim 15 wherein the combinations of audio signals comprise combinations of analog audio signals, the arrangement further comprising an analog-to-digital converter configured to convert the combinations of analog audio signals into combinations of digital audio signals, the transceiver being configured to transmit air-borne signals including the combinations of digital audio signals.

18. The arrangement of claim 17 wherein the mobile personal electronic device includes a digital-to-analog converter configured to convert the combinations of digital audio signals into combinations of analog audio signals.

19. The arrangement of claim 17 further comprising a server interconnecting the analog-to-digital converter and the transceiver.

20. The arrangement of claim 15 wherein the transceiver comprises a Wi-Fi direct transceiver.
